(19) United States
(12) Patent Application Publication
(10) Pub. No.: US 2025/0192317 A1
(43) Pub. Date: Jun. 12, 2025

(54) SYSTEMS AND METHODS FOR SEALING INTERFACES WITHIN TRACTION BATTERY PACKS

(71) Applicant: FORD GLOBAL TECHNOLOGIES, LLC, Dearborn, MI (US)

(72) Inventors: Michael E. Reibling, Sterling Heights, MI (US); Kanchana Perumalla, Troy, MI (US); Patrick Roxin, Livonia, MI (US); Samir Subba, Dearborn, MI (US)

(21) Appl. No.: 18/945,979

(22) Filed: Nov. 13, 2024

Related U.S. Application Data
(60) Provisional application No. 63/607,888, filed on Dec. 8, 2023.

(51) Int. Cl. H01M 50/262; H01M 10/625; H01M 10/6554; H01M 10/658; H01M 50/233; H01M 50/249; H01M 50/293

(52) U.S. Cl. CPC H01M 50/262; H01M 10/625; H01M 10/6554; H01M 10/658; H01M 50/233; H01M 50/249; H01M 50/293

(57) ABSTRACT

Battery cell stack designs are provided for traction battery packs. An exemplary cell stack may include a thermal barrier assembly that is arranged to inhibit the transfer of thermal energy between adjacent cell packets of battery cells of the cell stack. The thermal barrier assembly may include a first seal for sealing a first interface between a heat exchanger plate and the thermal barrier assembly. A second seal may be provided for sealing a second interface between the heat exchanger plate and a structural plate member of the cell stack. A third seal may be provided for sealing a third interface between the heat exchanger plate and cross-member assembly of the cell stack. The first, second, and third seals may cooperate to establish a seal system for sealing various gas paths across the heat exchanger plate, thereby preventing vent gases from passing from one battery cell packet to another during battery thermal events as part of a cell vent management strategy.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to seal systems that seal various interfaces inside a traction battery pack for providing cell vent management.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery cell stack, a heat exchanger plate, a first seal arranged to seal a first interface between a thermal barrier assembly of the battery cell stack and the heat exchanger plate, a second seal arranged to seal a second interface between a structural plate member of the traction battery pack and the heat exchanger plate, and a third seal arranged to seal a third interface between a cross-member assembly of the battery cell stack and the heat exchanger plate.

In a further non-limiting embodiment of the foregoing traction battery pack, the first seal is a bulb seal.

In a further non-limiting embodiment of either of the foregoing traction battery packs, the bulb seal includes a dome-like portion that interfaces with an exterior surface of the heat exchanger plate.

In a further non-limiting embodiment of any of the foregoing traction battery packs, the bulb seal includes a tongue that is received within a groove of a structural barrier of the thermal barrier assembly.

In a further non-limiting embodiment of any of the foregoing traction battery packs, the structural barrier includes a pultrusion.

In a further non-limiting embodiment of any of the foregoing traction battery packs, the structural barrier includes a notched section configured to accommodate an undulation provided within the heat exchanger plate.

In a further non-limiting embodiment of any of the foregoing traction battery packs, the heat exchanger plate extends beneath the structural plate member.

In a further non-limiting embodiment of any of the foregoing traction battery packs, the structural plate member extends along an axis that is substantially transverse to a longitudinal axis of the battery cell stack.

In a further non-limiting embodiment of any of the foregoing traction battery packs, the second seal includes an adhesive.

In a further non-limiting embodiment of any of the foregoing traction battery packs, the third seal includes an adhesive.

In a further non-limiting embodiment of any of the foregoing traction battery packs, the third seal is arranged between the heat exchanger plate and a pultrusion of the cross-member assembly.

In a further non-limiting embodiment of any of the foregoing traction battery packs, a fourth seal is arranged to seal a fourth interface between the thermal barrier assembly and an enclosure cover of the traction battery pack.

In a further non-limiting embodiment of any of the foregoing traction battery packs, the fourth seal includes an adhesive.

In a further non-limiting embodiment of any of the foregoing traction battery packs, the adhesive is received within a basin of a structural barrier of the thermal barrier assembly.

In a further non-limiting embodiment of any of the foregoing traction battery packs, a fifth seal is arranged to seal a fifth interface between the thermal barrier assembly and the cross-member assembly.

A traction battery pack according to another exemplary aspect of the present disclosure includes, among other things, an enclosure cover, a heat exchanger plate, a first cell packet of battery cells and a second cell packet of battery cells arranged to extend between the enclosure cover and the heat exchanger plate, a thermal barrier assembly positioned to separate the first cell packet from the second cell packet, a bulb seal arranged to seal a first gas path between the heat exchanger plate and the thermal barrier assembly, and a first adhesive arranged to seal a second gas path between the enclosure cover and the thermal barrier assembly.

In a further non-limiting embodiment of the foregoing traction battery pack, a second adhesive is arranged to seal a third gas path between the heat exchanger plate and a structural plate member of the traction battery pack.

In a further non-limiting embodiment of either of the foregoing traction battery packs, a third adhesive is arranged to seal a fourth gas path between the heat exchanger plate and a cross-member assembly of a cell stack that comprises the first cell packet and the second cell packet.

In a further non-limiting embodiment of any of the foregoing traction battery packs, the bulb seal includes a dome-like portion that interfaces with an exterior surface of the heat exchanger plate.

In a further non-limiting embodiment of any of the foregoing traction battery packs, the exterior surface includes at least one undulation.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIGS. 3 and 4 illustrate exemplary interfaces between a heat exchanger plate and each of a thermal barrier assembly and a structural plate member of the traction battery pack of FIG. 2.

FIG. 5 illustrates exemplary interfaces between a heat exchanger plate and each of a thermal barrier assembly and a cross-member assembly of the traction battery pack of FIG. 2.

FIG. 6 illustrates another exemplary interface between a heat exchanger plate and a structural plate member of a traction battery pack.

FIG. 7 illustrates yet another exemplary interface between a thermal barrier assembly and cross-member assembly of a traction battery pack.

### DETAILED DESCRIPTION

This disclosure details battery cell stack designs for traction battery packs. An exemplary cell stack may include a thermal barrier assembly that is arranged to inhibit the transfer of thermal energy between adjacent cell packets of battery cells of the cell stack. The thermal barrier assembly may include a first seal for sealing a first interface between a heat exchanger plate of the traction battery pack and the thermal barrier assembly. A second seal may be provided for sealing a second interface between the heat exchanger plate and a structural plate member of the cell stack. A third seal may be provided for sealing a third interface between the heat exchanger plate and cross-member assembly of the cell stack. The first, second, and third seals may cooperate to establish a seal system for sealing various gas paths across the heat exchanger plate, thereby preventing vent gases from passing from one battery cell packet to another during battery thermal events as part of a cell vent management strategy. These and other features are discussed in greater detail in the following paragraphs of this detailed description.

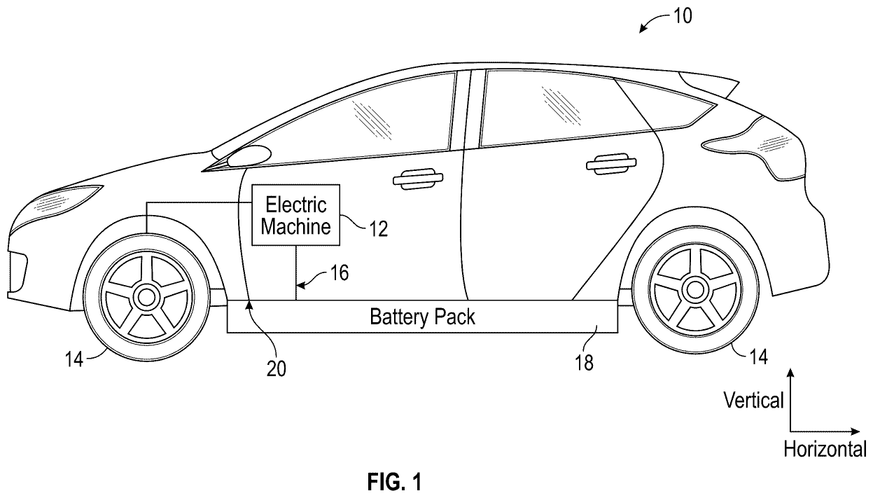

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

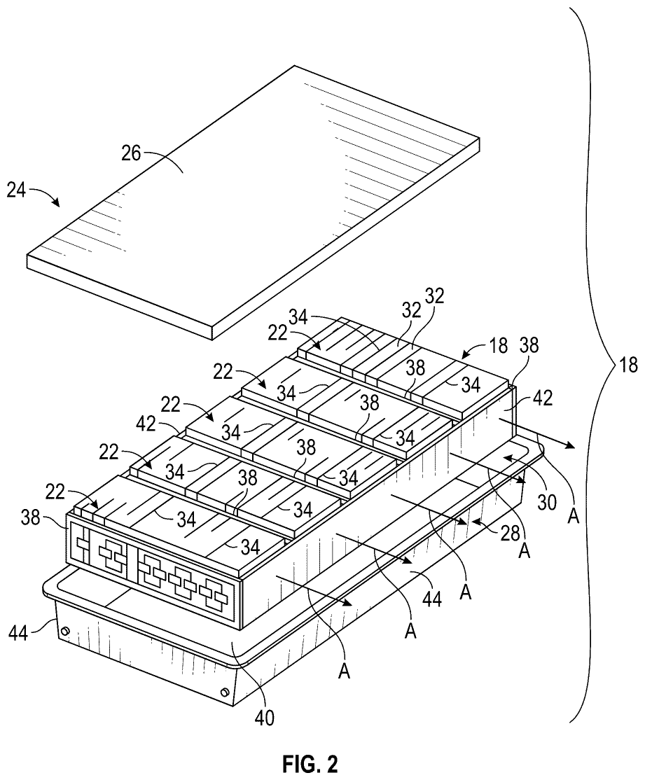

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments.

The battery cells 32 and the thermal barrier assemblies 34 of each cell stack 22 may be arranged to extend between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 are therefore configured to increase the structural integrity of the traction battery pack 18.

A vertically upper side of each cell stack 22 may interface with the enclosure cover 26, and a vertically lower side of each cell stack 22 may interface with a heat exchanger plate 40, sometimes referred to as a “cold plate,” that is positioned against a floor of the enclosure tray 28. Vertical and horizontal, for purposes of this disclosure, are with reference to ground and a general orientation of traction battery pack 18 when installed on the electrified vehicle 10 of FIG. 1.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g., perpendicular) to the cell stack axes A of the cell stacks 22 and to the cross-member assemblies 38. The structural plate members 42 can span across a majority of the length of the longitudinally extending side walls 44 of the enclosure tray 28 and are thus sometimes referred to as structural “megabars” of the traction battery pack 18. However, other configurations are contemplated within the scope of this disclosure.

In an embodiment, the cell stacks 22 and their respective cross-member assemblies 38 extend longitudinally in a cross-vehicle direction of the electrified vehicle 10, and the structural plate members 42 extend longitudinally in a length-wise direction of the electrified vehicle 10. However, other configurations are contemplated within the scope of this disclosure.

The structural plate members 42 may be secured to the cell stacks 22 for further structurally integrating the traction battery pack 18. For example, a plurality of fasteners (e.g., bolts or screws, not shown) may be inserted through the structural plate members 42 and can be accommodated within fastener openings of the cross-member assemblies 38 for securing the structural plate members 42 directly to the cell stacks 22. These connections can help contain tensile loads that can occur over the life of the cell stacks 22 as a result of battery cell expansion forces, for example.

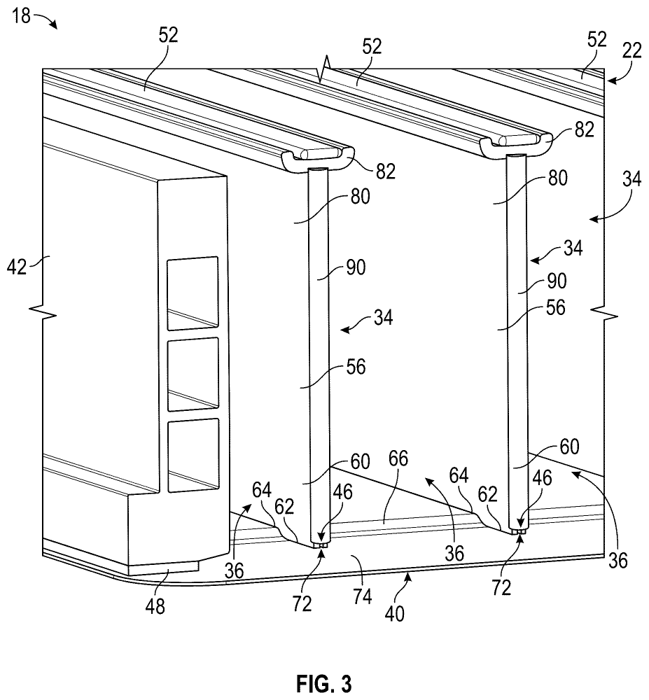

Referring now to FIGS. 3, 4, and 5, with continued reference to FIGS. 1-2, a seal system may be provided for sealing various interfaces within the traction battery pack 18. For example, the seal system may be configured for sealing various gas paths inside the traction battery pack 18 in order to provide cell vent management.

In an exemplary embodiment, the seal system includes a first seal 46 for sealing a first interface between the heat exchanger plate 40 and each thermal barrier assembly 34 of the cell stack 22, a second seal 48 for sealing a second interface between the heat exchanger plate 40 and each structural plate member 42 of the traction battery pack 18, a third seal 50 for sealing a third interface between the heat exchanger plate 40 and each cross-member assembly 38 of the cell stack 22, a fourth seal 52 for sealing an interface between each thermal barrier assembly 34 of the cell stack 22 and the enclosure cover 26 of the traction battery pack 18, and a fifth seal 90 for sealing an interface between each thermal barrier assembly 34 of the cell stack 22 each cross-member assembly 38 of the cell stack 22. Each of these seals is described in further detail below.

One or more of the thermal barrier assemblies 34 may be arranged along the respective cell stack axis A of each cell stack 22. The thermal barrier assemblies 34 may compartmentalize each cell stack 22 into two or more subgroupings or compartments 36 of battery cells 32. Each compartment 36 may hold one or more of the battery cells 32 of the cell stack 22.

A cell packet 54 may be positioned within each compartment 36 of the cell stack 22. Each cell packet 54 may be separated from a neighboring cell packet 54 by one of the thermal barrier assemblies 34. Each cell packet 54 may include two or more battery cells 32. Notably, the cell packets 54 are shown in FIG. 4 but are omitted in FIG. 3 for clarity.

Should, for example, a battery thermal event occur from within one of the cell packets 54, the thermal barrier assemblies 34 may reduce or even prevent thermal energy associated with the thermal event from moving from cell packet-to-cell packet across the length of the cell stack 22, thereby inhibiting the transfer of thermal energy inside the traction battery pack 18.

Each thermal barrier assembly 34 of the cell stack 22 may include a structural barrier 56 that is flanked by pairs of thermal resistance material layers 58 (see FIG. 4) as part of a multi-layered structure of the thermal barrier assembly 34. The structural barrier 56 may be sandwiched between the thermal resistance material layers 58. The thermal resistance material layers 58 can be positioned in abutting contact with major side surfaces of battery cells 32 located in adjacent compartments 36 of the cell stack 22.

The structural barriers 56 may each include a thermoplastic structure or a polymer composite structure (e.g., glass fiber reinforced polypropylene with an intumescent additive), for example, and the thermal resistance material layers 58 may include aerogel layers or mica sheets, for example. However, other materials or combinations of materials could be utilized to construct the subcomponents of the thermal barrier assembly 34 within the scope of this disclosure.

The structural barrier 56 of each thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 56 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 56. In other implementations, the structural barrier 56 could be an injection molded part or an extruded part.

The structural barrier 56 of the thermal barrier assembly 34 may include a lower interfacing structure 60 that is configured to interface with the heat exchanger plate 40. The lower interfacing structure 60 may include a bottom edge 62 that includes a notched section 64 (best seen in FIG. 3). The notched section 64 may be configured for accommodating a contour of the heat exchanger plate 40. For example, the notched section 64 may accommodate an undulation 66 (see FIG. 3) of the heat exchanger plate 40. The undulation 66 causes height variations in the heat exchanger plate 40.

The first seal 46 may be attached to the bottom edge 62 of the lower interfacing structure 60 of the structural barrier 56. In an embodiment, the bottom edge 62 includes a groove 68 that receives a tongue 70 of the first seal 46 for securing the first seal 46 to the structural barrier 56 of the thermal barrier assembly 34 (see FIG. 4). However, other attachment methodologies, including but not limited to one in which the bottom edge 62 includes the tongue and the first seal 46 includes the groove, are contemplated within the scope of this disclosure.

In an embodiment, the first seal 46 is a bulb seal that includes a dome-like portion 72 that extends from the tongue 70. The dome-like portion 72 may be received in contact with an exterior surface 74 of the heat exchanger plate 40 for sealing the interface between the thermal barrier assembly 34 and the heat exchanger plate 40. The first seal 46 is thus arranged to seal the gas path between the thermal barrier assembly 34 and the heat exchanger plate 40. Accordingly, in the event of a battery thermal event in which one or more battery cells 32 of one of the cell packets 54 release vent gases, the first seal 46 can prevent the vent gases from passing from the venting cell packet 54 to a neighboring cell packet 54 at the interface between thermal barrier assembly 34 and the heat exchanger plate 40. By virtue of the first seals 46, each cell packet 54 of the cell stack 22 has a sealed venting path and controlled vent gas exit.

The dome-like portion 72 of the first seal 46 may be at least partially hollow and may flex or compress when positioned in contact with the exterior surface 74 of the heat exchanger plate 40. The first seal 46 may therefore accommodate for the dimensional variations caused by the undulations 66 of the heat exchanger plate 40 and can maintain an adequate seal between the thermal barrier assembly 34 and the heat exchanger plate 40.

In an embodiment, the first seal 46 is made of a compressible material, such as rubber or a silicone-based material, for example. In another embodiment, the first seal 46 is an extruded part. However, other compressible materials or combinations of materials and/or manufacturing techniques are contemplated within the scope of this disclosure.

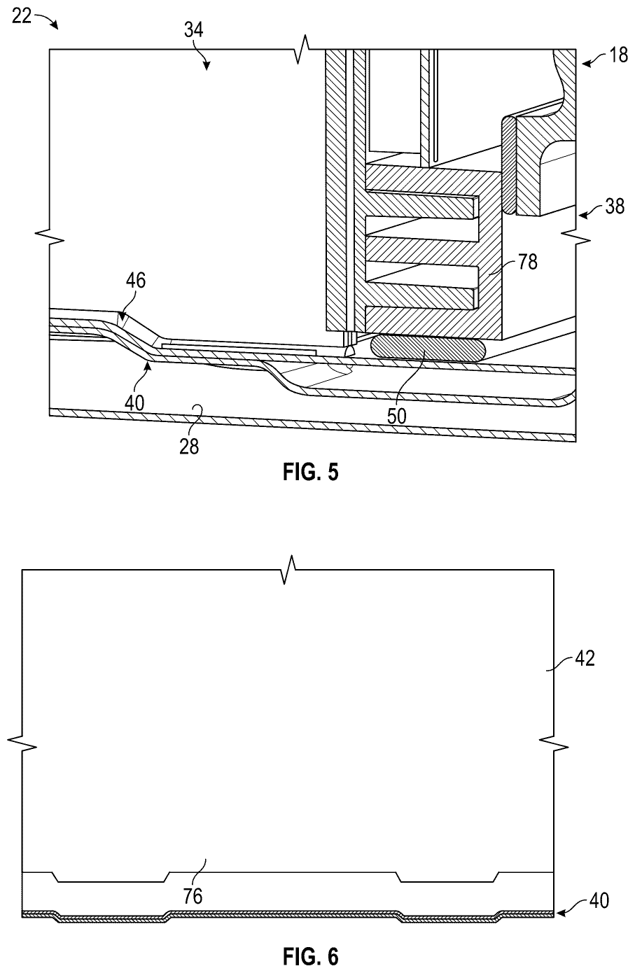

The heat exchanger plate 40 may extend underneath each of the structural plate members 42 of the traction battery pack 18. The second seal 48 may be arranged between the heat exchanger plate 40 and each structural plate member 42. The second seals 48 can therefore seal a gas path between the heat exchanger plate 40 and the structural plate member 42. In some implementations, a bottom edge 76 of the structural plate member 42 may be machined to follow the undulated contour of the heat exchanger plate 40 (see, e.g., FIG. 6).

In an embodiment, the second seal 48 is an adhesive. The second seal 48 may be an epoxy based adhesive or a urethane based adhesive, for example. However, other types of adhesives are contemplated within the scope of this disclosure.

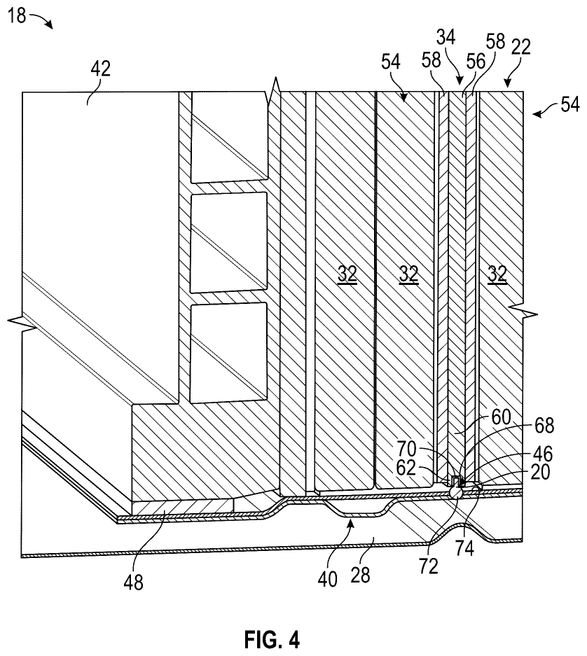

The third seal 50 (see FIG. 5) may be arranged between the heat exchanger plate 40 and each cross-member assembly 38 of the cell stack 22. The third seals 50 can therefore seal gas paths between adjacent cell stacks 22 for providing cell vent management within the traction battery pack 18. In an embodiment, the third seal 50 is arranged between the heat exchanger plate 40 and a pultrusion 78 (see FIG. 5) of the cross-member assembly 38. However, other configurations are contemplated within the scope of this disclosure.

In an embodiment, the third seal 50 is an adhesive. The third seal 50 may be an epoxy based adhesive or a urethane based adhesive, for example. However, other types of adhesives are contemplated within the scope of this disclosure.

The structural barrier 56 of each thermal barrier assembly 34 may additionally include an upper interfacing structure 80 that is configured to interface with the enclosure cover 26. The upper interfacing structure 80 may be disposed on an opposite end of the structural barrier 56 from the lower interfacing structure 60.

The upper interfacing structure 80 may include a dish-like basin 82 (see FIG. 3). The fourth seal 52 may be positioned within the dish-like basin 82 for sealing an interface between the thermal barrier assembly 34 and the enclosure cover 26. The fourth seal 52 is thus arranged to seal the gas path between the thermal barrier assembly 34 and the enclosure cover 26. Accordingly, in the event of a battery thermal event in which one or more battery cells 32 of one of the cell packets 54 release vent gases, the fourth seal 52 can prevent the vent gases from passing from the venting cell packet 54 to a neighboring cell packet 54 at the interface between thermal barrier assembly 34 and the enclosure cover 26. By virtue of the first seals 46 and the fourth seals 52, each cell packet 54 has a sealed venting path and controlled vent gas exit.

In an embodiment, the fourth seal 52 is a thermally conductive structural adhesive. However, other types of adhesives are contemplated within the scope of this disclosure.

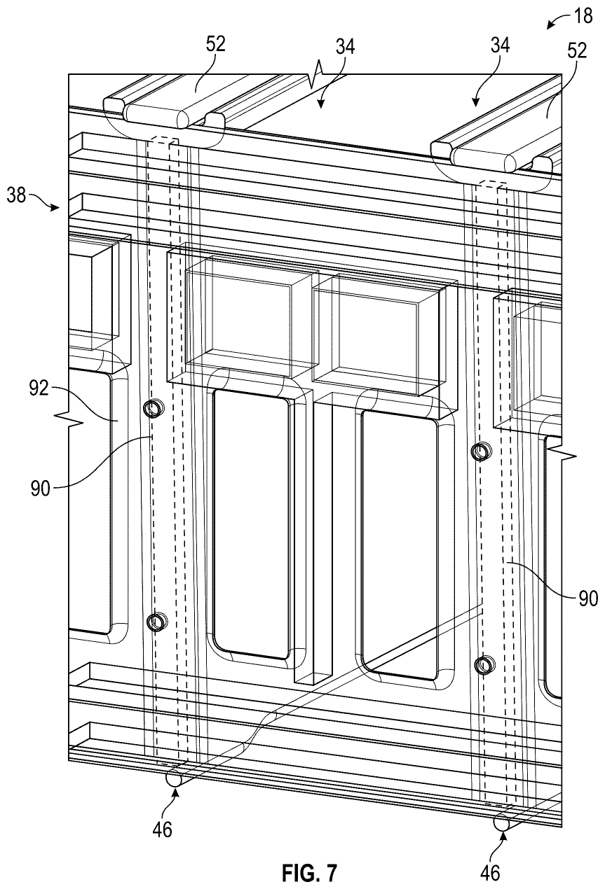

The fifth seal 90 (see FIGS. 3 and 7) may be arranged between each thermal barrier assembly 34 and each cross-member assembly 38 of the cell stack 22. The fifth seals 90 can therefore seal gas paths between the battery cells 32 and the cross-member assemblies 38 for providing cell vent management within the traction battery pack 18. In an embodiment, the fifth seal 90 is arranged between the structural barrier 56 of thermal barrier assembly 34 and a ladder frame 92 (see FIG. 7) of the cross-member assembly 38. However, other configurations are contemplated within the scope of this disclosure.

In an embodiment, the fifth seal 90 is a thermally conductive structural adhesive. However, other types of adhesives are contemplated within the scope of this disclosure.

The exemplary traction battery packs of this disclosure include a seal system for sealing multiple interfaces inside the traction battery pack in order to provide sealed cell packet venting paths and controlled vent gas exits. The proposed seal system may seal the interfaces between a heat exchanger plate of the traction battery pack and each of thermal barrier assemblies, cross-member assemblies, and structural plate members, thereby providing cell vent management.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell stack;
a heat exchanger plate;
a first seal arranged to seal a first interface between a thermal barrier assembly of the battery cell stack and the heat exchanger plate;
a second seal arranged to seal a second interface between a structural plate member of the traction battery pack and the heat exchanger plate; and
a third seal arranged to seal a third interface between a cross-member assembly of the battery cell stack and the heat exchanger plate.

2. The traction battery pack as recited in claim 1, wherein the first seal is a bulb seal.

3. The traction battery pack as recited in claim 2, wherein the bulb seal includes a dome-like portion that interfaces with an exterior surface of the heat exchanger plate.

4. The traction battery pack as recited in claim 2, wherein the bulb seal includes a tongue that is received within a groove of a structural barrier of the thermal barrier assembly.

5. The traction battery pack as recited in claim 4, wherein the structural barrier includes a pultrusion.

6. The traction battery pack as recited in claim 5, wherein the structural barrier includes a notched section configured to accommodate an undulation provided within the heat exchanger plate.

7. The traction battery pack as recited in claim 1, wherein the heat exchanger plate extends beneath the structural plate member.

8. The traction battery pack as recited in claim 7, wherein the structural plate member extends along an axis that is substantially transverse to a longitudinal axis of the battery cell stack.

9. The traction battery pack as recited in claim 1, wherein the second seal includes an adhesive.

10. The traction battery pack as recited in claim 1, wherein the third seal includes an adhesive.

11. The traction battery pack as recited in claim 1, wherein the third seal is arranged between the heat exchanger plate and a pultrusion of the cross-member assembly.

12. The traction battery pack as recited in claim 1, comprising a fourth seal arranged to seal a fourth interface between the thermal barrier assembly and an enclosure cover of the traction battery pack.

13. The traction battery pack as recited in claim 12, wherein the fourth seal includes an adhesive.

14. The traction battery pack as recited in claim 13, wherein the adhesive is received within a basin of a structural barrier of the thermal barrier assembly.

15. The traction battery pack as recited in claim 12, comprising a fifth seal arranged to seal a fifth interface between the thermal barrier assembly and the cross-member assembly.

16. A traction battery pack, comprising:
an enclosure cover;
a heat exchanger plate;
a first cell packet of battery cells and a second cell packet of battery cells arranged to extend between the enclosure cover and the heat exchanger plate;
a thermal barrier assembly positioned to separate the first cell packet from the second cell packet;
a bulb seal arranged to seal a first gas path between the heat exchanger plate and the thermal barrier assembly; and
a first adhesive arranged to seal a second gas path between the enclosure cover and the thermal barrier assembly.

17. The traction battery pack as recited in claim 16, comprising a second adhesive arranged to seal a third gas path between the heat exchanger plate and a structural plate member of the traction battery pack.

18. The traction battery pack as recited in claim 16, comprising a third adhesive arranged to seal a fourth gas path between the heat exchanger plate and a cross-member assembly of a cell stack that comprises the first cell packet and the second cell packet.

19. The traction battery pack as recited in claim 16, wherein the bulb seal includes a dome-like portion that interfaces with an exterior surface of the heat exchanger plate.

20. The traction battery pack as recited in claim 19, wherein the exterior surface includes at least one undulation.
